(19) United States
(12) Patent Application Publication
(10) Pub. No.: US 2010/0038465 A1
(43) Pub. Date: Feb. 18, 2010

(54) RECORDING TAPE CARTRIDGE

(75) Inventor: Kenji TAKENOSHITA, Kanagawa (JP)

Correspondence Address: Solaris Intellectual Property Group, PLLC, 401 Holland Lane, Suite 407, Alexandria, VA, 22314, US

(73) Assignee: FUJIFILM CORPORATION, Tokyo (JP)

(21) Appl. No.: 12/512,072

(22) Filed: Jul. 30, 2009

(30) Foreign Application Priority Data
Aug. 15, 2008 (JP) 2008-209252

(51) Int. Cl. G11B 23/107

(52) U.S. Cl. 242/348

(57) ABSTRACT

A recording tape cartridge includes: a reel that includes a bottomed circular cylinder-shaped hub; a case that includes a top plate and a bottom plate, with the reel being singly housed in the case such that the reel is movable along an axial line direction between the top plate and the bottom plate; a ring-shaped member that is fixedly attached to the inner peripheral surface of the hub; an engagement gear formed on the ring-shaped member such that its teeth surface is substantially parallel to the axial line of the reel; and a brake member having a brake gear that is capable of meshing with the engagement gear. The brake gear, by being displaced in the axial line direction of the reel, can take a rotation lock position where the brake gear meshes with the engagement gear and a rotation allowance position where the meshing is released.

### CROSS-REFERENCE TO RELATED APPLICATION

This application claims priority under 35 USC 119 from Japanese Patent Application No. 2008-209252 filed on Aug. 15, 2008, the disclosure of which is incorporated by reference herein.

### BACKGROUND OF THE INVENTION

1. Field of the Invention

The present invention relates to a recording tape cartridge where a reel, onto which is wound recording tape such as magnetic tape, is singly housed inside a case.

2. Description of the Related Art

Conventionally, there have been known recording tape cartridges where an engagement gear is annularly and integrally formed on a lower end portion of an inner peripheral surface of a hub of a reel and where a brake gear that is formed on an outer peripheral surface of a brake member that is configured so as to be incapable of rotating with respect to a case is caused to engage with this engagement gear, whereby the brake member locks rotation of the reel with respect to the case (e.g., see Japanese Patent Application Laid-Open Publication (JP-A) No. 2005-196938). Further, there have also been known recording tape cartridges equipped with a reel where a separate ring-shaped member is inserted on the inner peripheral surface side of the hub in order to raise the strength of the hub (e.g., see JP-A No. 2004-127358).

In this connection, in the reel described in JP-A No. 2005-196938, the engagement gear is annularly and integrally formed on the lower end portion of the inner peripheral surface of the hub, so the plate thickness of the hub on its lower end portion side is thicker than the plate thickness of the hub on its upper end portion side and the rigidity of the hub on its lower end portion side is higher than the rigidity of the hub on its upper end portion side. Consequently, in the instance of this reel, there is the problem that it becomes easier for the upper end portion side of the hub to deform than the lower end portion side due to winding constriction of the recording tape wound around the hub.

In other words, there is the fear that a difference in diameter will arise between the upper side and the lower side of the hub and adversely affect the recording tape wound around the hub due to winding constriction of the recording tape wound around the hub. It will be noted that, in the reel described in JP-A No. 2004-127358, the ring-shaped member is disposed on the upper portion side (the upper portion side from the substantial center portion) of the hub, but even when the recording tape cartridge is configured in this manner, there are instances where an effect that is sufficient for reducing a difference between the upper and lower diameters of the hub cannot be expected.

### SUMMARY OF THE INVENTION

Thus, in view of the above-described circumstance, the present invention provides a recording tape cartridge equipped with a reel that can reduce a difference between the upper and lower diameters of the hub resulting from winding constriction of the recording tape.

A recording tape cartridge pertaining to a first aspect of the invention includes: a reel that includes a bottomed circular cylinder-shaped hub onto whose outer peripheral surface is wound recording tape; a case that includes a top plate and a bottom plate that face each other, with the reel being singly housed in the case such that the reel is movable along an axial line direction between the top plate and the bottom plate; a ring-shaped member that is fixedly attached to the inner peripheral surface of the hub; an engagement gear that is formed on the ring-shaped member such that its tooth surface is substantially parallel to the axial line of the reel; and a brake member that is supported so as to be incapable of rotating with respect to the case, includes a brake gear that is capable of meshing with the engagement gear, and, by being displaced in the axial line direction of the reel with respect to the hub, can take a rotation lock position where the brake gear meshes with the engagement gear and a rotation allowance position where the meshing is released.

According to the recording tape cartridge pertaining to the first aspect of the invention, when the recording tape cartridge is not in use such as during storage or during transport, for example, the brake gear of the brake member that is configured to be incapable of rotating with respect to the case meshes with the engagement gear of the ring-shaped member that is fixedly attached to the inner peripheral surface of the hub, whereby relative rotation of the reel with respect to the case is locked. Here, the tooth surface (meshing surface) of the engagement gear is formed substantially parallel to the axial line of the reel, and the brake gear is formed so as to be capable of meshing with that engagement gear.

Consequently, even if the recording tape cartridge were to be dropped such that the drop impact thereof is applied to the case and such that the reel and the brake member relatively slant, there is no fear that the meshing of the brake gear with respect to the engagement gear will be released, and the meshing (overlap in the axial line direction) amount between the engagement gear and the brake gear is ensured. Thus, the rotation lock state of the reel with respect to the case is maintained.

Further, the engagement gear with which the brake gear of the brake member meshes is formed on the ring-shaped member, and that ring-shaped member is fixedly attached to the inner peripheral surface of the hub. Consequently, the plate thickness of the hub can be made substantially more even in the up-and-down direction than that of a conventional hub where the engagement gear is formed integrally. Thus, a difference between the upper and lower diameters of the hub resulting from winding constriction of the recording tape can be reduced.

Further, in the recording tape cartridge pertaining to the first aspect of the invention, the engagement gear may be formed on the hub bottom wall side of the ring-shaped member, and a space may be formed between the outer peripheral surface of the ring-shaped member on the bottom wall side where the engagement gear is formed and the inner peripheral surface of the hub.

In the recording tape cartridge pertaining to the first aspect of the invention, because of the above-described configuration, the ring-shaped member is configured so as to not contact the bottom wall side of the hub whose rigidity is higher than that of the upper end side of the hub, so a situation where the rigidity of the bottom wall side of the hub becomes higher than the rigidity of the upper end side of the hub can be controlled or prevented. Consequently, a difference between the upper and lower diameters of the hub resulting from winding constriction of the recording tape can be effectively reduced. Further, design of the engagement gear becomes easy because contraction of the engagement gear resulting from winding constriction of the recording tape can be prevented.

Further, in the recording tape cartridge pertaining to the first aspect of the invention, the ring-shaped member may be formed by a material of a higher strength than the hub.

In the recording tape cartridge pertaining to the first aspect of the invention, because of the above-described configuration, collapse of the hub toward the center of rotation of the reel resulting from winding constriction of the recording tape can be effectively controlled or prevented.

Further, the recording tape cartridge pertaining to the first aspect of the invention may further includes: a first energizing member (a first urging member) that applies an energizing force (urging force) that biases the reel toward the bottom plate and biases the brake member toward the rotation lock position, lock members that are plurally disposed along a circumferential direction of the hub and can take a regulation position where the lock members enter between an end portion of the reel on the top plate side and the top plate in a state where the reel is biased toward the bottom plate, and regulate movement of the reel in the axial direction with respect to the case, and a regulation release position where the lock members retract from the regulation position and allow movement of the reel in the axial line direction with respect to the case, second energizing members (second urging members) that apply energizing forces (urging force) that bias the lock members toward the regulation position, and a lock release mechanism that includes pressed portions that are disposed on the plural lock members and pressing portions that are disposed on the brake member, with the lock release mechanism causing the plural lock members to move from the regulation position to the regulation release position as a result of the pressing portions pressing the pressed portions in accompaniment with the brake member moving from the rotation lock position to the rotation release position.

In the recording tape cartridge pertaining to the first aspect of the invention, because of the above-described configuration, when the recording tape cartridge is not in use, the lock members are biased in the regulation position by the energizing forces of the second energizing members and enter between the reel that is biased toward the bottom plate by the energizing force of the first energizing member and the case top plate, so rotation (relative displacement) of the reel in the axial line direction with respect to the hub is limited. Consequently, even if the recording tape cartridge were to be dropped such that the drop impact thereof is applied to the case, slanting of the reel with respect to the case is controlled, and the relative slanting amount between the brake member and the reel is also controlled.

Moreover, the tooth surface (meshing surface) of the engagement gear that is formed on the ring-shaped member that is fixedly attached to the inner peripheral surface of the hub is configured to be substantially parallel to the axial line of the reel, and the brake gear of the brake member is caused to mesh with that engagement gear to lock rotation of the reel with respect to the case, so it is easy for the meshing between the engagement gear and the brake gear to be maintained within the range of the relative slanting amount between the reel and the brake member that is limited by the lock members.

In other words, because the meshing surface between the engagement gear and the brake gear is substantially parallel to the axial line direction of the reel, there is no situation where a reel rotational force resulting from a drop impact causes a thrust force to arise between the engagement gear and the brake gear (the thrust force is remarkably small), and the rotation lock state of the reel with respect to the case is excellently maintained simply by the meshing being slightly maintained.

As described above, according to the present invention, there can be provided a recording tape cartridge equipped with a reel that can reduce a difference between the upper and lower diameters of the hub resulting from winding constriction of the recording tape.

### BRIEF DESCRIPTION OF THE DRAWINGS

FIG. 1 is a general perspective view showing a recording tape cartridge;

FIG. 2 is a general side sectional view showing a state where the recording tape cartridge is not in use;

FIG. 3 is a general side sectional view showing a state where the recording tape cartridge is in use (a state where a reel is rotating);

FIG. 4 is a partially cutaway general exploded perspective view showing the reel and a ring-shaped member;

FIG. 5 is a partially enlarged general side sectional view showing the configuration of the reel;

FIG. 6 is a partially cutaway general perspective view showing a reel lock state with respect to the reel;

FIG. 7 is a general exploded perspective view showing a reel lock mechanism with respect to the reel;

FIG. 8 is a general perspective view showing a provisional assembled state of the reel lock mechanism with respect to the reel;

FIG. 9 is a general side sectional view showing a held state of leader tape with respect to a case;

FIG. 10 is a partially enlarged general side sectional view showing a reel lock release process of the recording tape cartridge;

FIG. 11 is a partially enlarged general side sectional view showing the reel lock release process of the recording tape cartridge; and

FIG. 12 is a partially enlarged general side sectional view showing a reel rotation state of the recording tape cartridge.

### DETAILED DESCRIPTION OF THE INVENTION

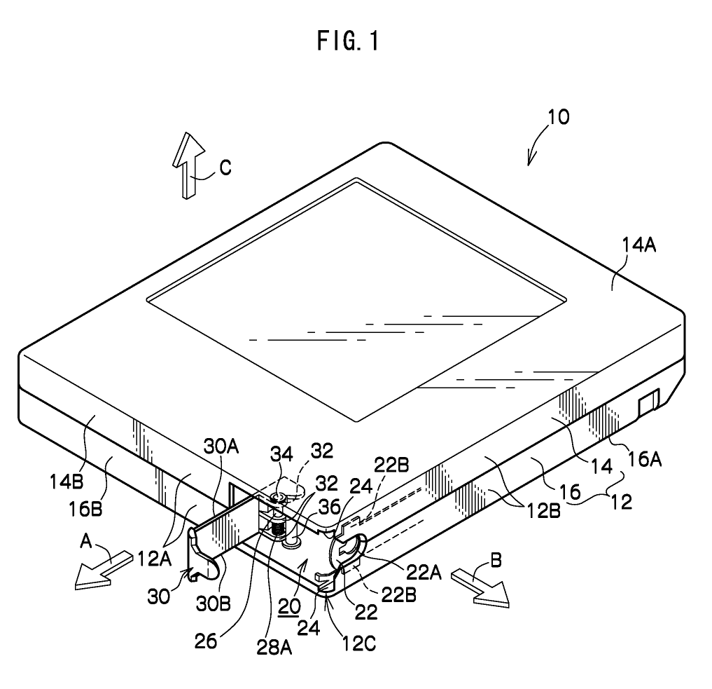

Below, the best mode for implementing the present invention will be described in detail on the basis of an embodiment shown in the drawings. It will be noted that, for the sake of convenience of description, the direction in which a recording tape cartridge 10 is loaded into a drive device (the direction of arrow A appropriately shown in FIG. 1, etc.) will be called a front direction and that the direction of arrow B and the direction of arrow C, which are respectively orthogonal to the direction of arrow A, will be respectively called a left direction and an up direction.

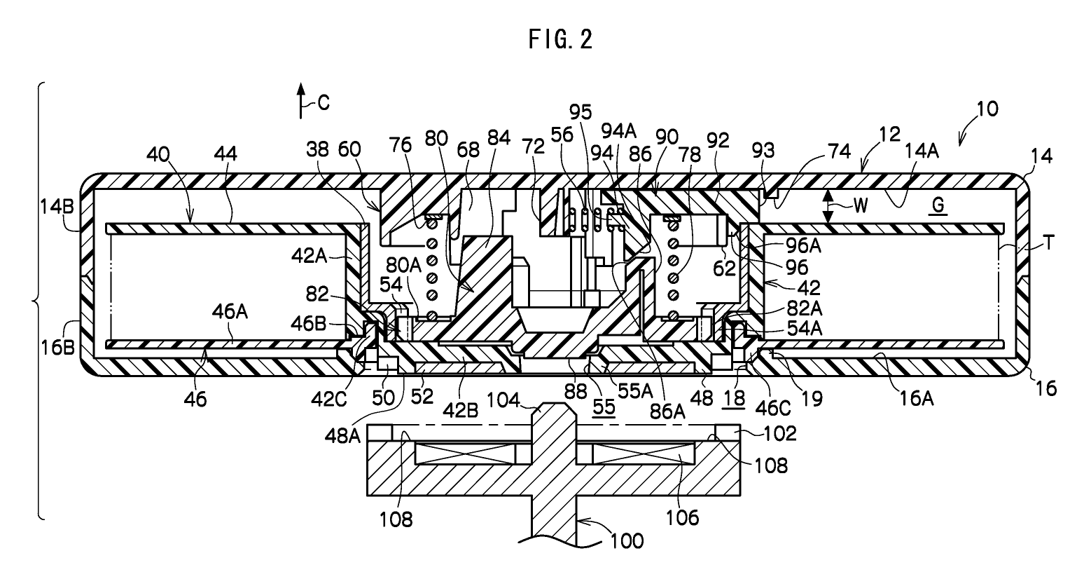

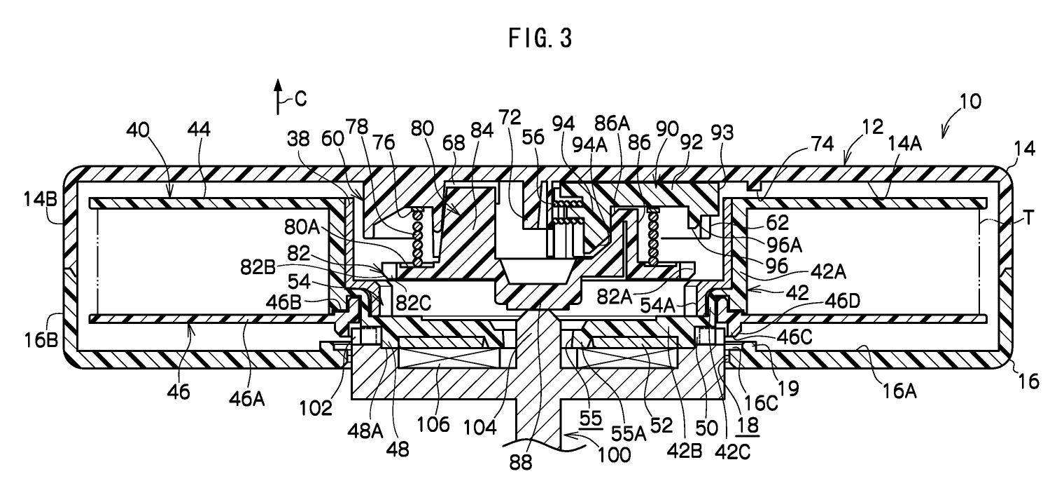

First, the general overall configuration of the recording tape cartridge 10 will be described. In FIG. 1, there is shown the exterior of the recording tape cartridge 10 in a perspective view. Further, in FIG. 2, there is shown a cross-sectional view of the recording tape cartridge 10 when the recording tape cartridge 10 is not in use. In FIG. 3, there is shown a cross-sectional view of the recording tape cartridge 10 when the recording tape cartridge 10 is in use. As shown in these drawings, the recording tape cartridge 10 is equipped with a case 12. The case 12 is configured by joining together an upper case 14 and a lower case 16.

Specifically, the upper case 14 is configured as a result of a substantially frame-shaped peripheral wall 14B being disposed upright along the outer edge of a top plate 14A that is substantially rectangular when seen in a planar view, and the lower case 16 is configured as a result of a peripheral wall 16B being disposed upright along the outer edge of a bottom plate 16A that has a shape substantially corresponding to that of the top plate 14A. Additionally, the case 12 is formed in a substantially rectangular box shape as a result of the upper case 14 and the lower case 16 being joined together by ultrasonic welding or with screws in a state where the open end of the peripheral wall 14B and the open end of the peripheral wall 16B have been brought into contact with each other.

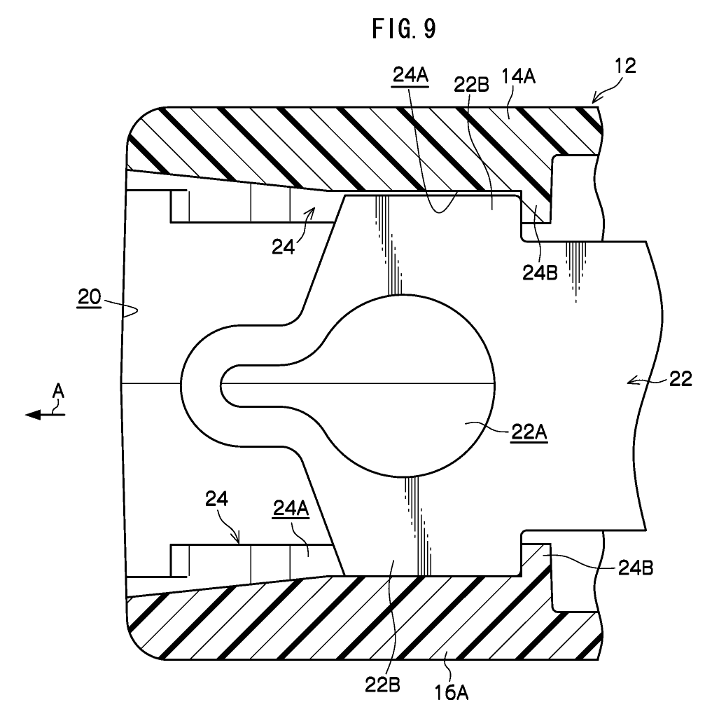

As shown in FIG. 2, a later-described reel 40 is rotatably singly housed inside the case 12. Magnetic tape T that serves as recording tape is wound onto this reel 40, and leader tape 22 that serves as a leader member is disposed on the leading end of the magnetic tape T (see FIG. 1 and FIG. 9). Further, a gear opening 18 for driving the reel 40 to rotate from the outside is disposed in the bottom plate 16A of this case 12. It will be noted that the configuration around the gear opening 18 will be described later together with the reel 40.

Further, an opening 20 for pulling out the magnetic tape T wound onto the reel 40 to the outside is formed in the vicinity of a corner portion 12C on the front left side of the case 12 that is a boundary portion between a front wall 12A (a front-facing wall configured by the peripheral wall 14B and the peripheral wall 16B) and a left side wall 12B (a left-facing wall configured by the peripheral wall 14B and the peripheral wall 16B) of the case 12.

This opening 20 is formed across the front wall 12A and the left side wall 12B that border the corner portion 12C. Additionally, in the recording tape cartridge 10 pertaining to the present embodiment, the leader tape 22, which is fixedly attached to the end portion of the magnetic tape T and is disposed along the left side wall 12B, is configured to be pulled out from the opening 20.

The leader tape 22 is a pulled-out member with which a pullout member (not shown) of the drive device engages in order for the pullout member to pull out the magnetic tape T, and the leader tape 22 is configured by a tape-like member that has substantially the same width as that of the magnetic tape T and a higher strength than that of the magnetic tape T. A hole portion 22A with which the pullout member engages is drilled in the leader tape 22 in the vicinity of the leading end of the leader tape 22, and projecting portions 22B that respectively project in the width direction (up direction or down direction) are formed on both the upper and lower sides of the leader tape 22 slightly to the rear of the leading end of that hole portion 22A.

These projecting portions 22B are housed in (inserted into) slot portions 24 that serve as housing portions that are respectively formed in the inner surface of the top plate 14A of the upper case 14 and in the inner surface of the bottom plate 16A of the lower case 16, whereby the leader tape 22 is held inside the case 12. It will be noted that, as shown in FIG. 9, each of the slot portions 24 includes a groove portion 24A whose longitudinal direction is in the front-rear direction and which opens frontward and a stopper wall portion 24B for regulating further movement of the projecting portions 22B housed in the groove portions 24A into the inside of the case (rearward).

Further, the opening 20 is blocked off by a door 30 when the recording tape cartridge 10 is not in use. The door 30 is formed in a substantial “L” shape when seen in a planar view and has substantially the same shape and the same size as those of the opening 20. It will be noted that it is preferable for this door 30 to be formed by an olefin resin such as POM (polyacetal), but the door 30 may also be formed by a resin material such as PC (polycarbonate) or a metal material such as SUS (stainless steel).

Further, this door 30 is configured to open and close the opening 20 by pivoting using, as a pivot fulcrum, a pivot 26 that is respectively disposed on, so as to project from, the front wall 12A side of the upper case 14 and the lower case 16. That is, three flat plate-shaped rotation slide portions 32 are disposed parallel to each other on, so as to project from, the door 30 in the vicinity of the right end portion (a position offset a predetermined distance to the left of the right end portion) on the inner surface side of the door 30.

These rotation slide portions 32 are respectively disposed on, so as to project from, both the upper and lower end portions of the inner surface of the door 30 and a midway portion slightly offset downward from the center, and through holes into which the pivots 26 loosely fit are drilled in the rotation slide portions 32. Consequently, the pivot 26 is inserted through the through holes 26, whereby the door 30 is pivotably supported.

Further, annular convex portions 34 are respectively formed around the through holes on the upper surface of the rotation slide portion 32 on the upper end portion and on the undersurface of the rotation slide portion 32 on the lower end portion. Additionally, these annular convex portions 34 respectively contact the inner surface of the top plate 14A and the inner surface of the bottom plate 16A, whereby a clearance of about 0.3 mm to about 0.5 mm is formed between an upper end surface 30A of the door 30 and the inner surface of the top plate 14A and between a lower end surface 30B of the door 30 and the inner surface of the bottom plate 16A; thus, sliding resistance between the case 12 and the door 30 is reduced.

Further, this door 30 is configured to pivot in the direction in which the door 30 opens the opening 20 as a result of the portion of the door 30 on the right side of the pivot 26 being pressed by an opening/closing member (not shown) of the drive device. Consequently, a coiled portion of a torsion spring 28 that always energizes the door 30 in the direction in which the door 30 blocks off the opening 20 is fitted around the pivot 26.

That is, the coiled portion of this torsion spring 28 is fitted around and attached to the pivot 26 between the rotation slide portion 32 on the lower end portion and the rotation slide portion 32 on the midway portion. Additionally, one end portion side of the torsion spring 28 is locked to a screw boss 36 of the case 12 (a screw boss disposed on, so as to project from, the lower case 16), and the other end portion side of the torsion spring 28 is locked to the right side portion of the door 30 with respect to the rotation slide portions 32.

Because of the above, the door 30 is configured such that, when the recording tape cartridge 10 is not in use, the door 30 blocks off the opening 20 because of the energizing force of the torsion spring 28, and, in accompaniment with the act of the recording tape cartridge 10 being loaded into the drive device, the portion of the door 30 on the right side of the pivot 26 is pressed by the opening/closing member, whereby the door 30 pivots counter to the energizing force of the torsion spring 28 and opens the opening 20.

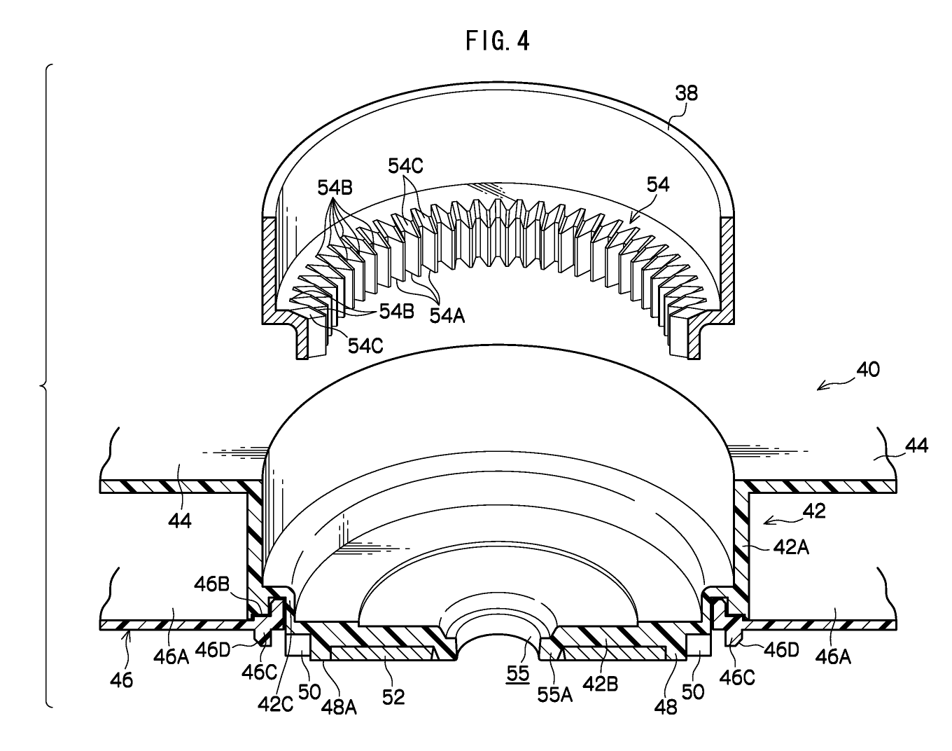

Next, the reel 40 will be described. As shown in FIG. 4 to FIG. 6, the reel 40 is equipped with a reel hub 42 that configures the axial center portion of the reel 40. The reel hub 42 is equipped with a circular cylinder portion 42A around whose outer peripheral surface is wound the magnetic tape T. Further, the reel hub 42 is equipped with a substantially disc-shaped bottom plate portion 42B that serves as a bottom wall and a substantially short circular cylinder-shaped inner circular cylinder portion 42C that interconnects the outer peripheral portion of the bottom plate portion 42B and the inner periphery of the lower portion of the circular cylinder portion 42A. It will be noted that a clearance is formed between the inner circular cylinder portion 42C and the vicinity of the lower end portion of the circular cylinder portion 42A. Further, the bottom plate portion 42B projects further downward than the lower end of the circular cylinder portion 42A.

An upper flange 44 is coaxially and integrally disposed on the open end (upper end) of the circular cylinder portion 42A of this reel hub 42 so as to extend outward in the radial direction. That is, the reel hub 42 is configured such that its strength (rigidity) with respect to winding constriction of the magnetic tape T or the like becomes relatively higher as a result of the upper flange 44 being integrally formed on the open end side of the reel hub 42. It will be noted that the reel hub 42 and the upper flange 44 of this reel 40 are integrally molded by a resin material and that the upper end surface of the circular cylinder portion 42A and the upper surface of the upper flange 44 are configured to be even.

A lower flange member 46 is joined together with the lower end portion of the circular cylinder portion 42A by ultrasonic welding or the like. The lower flange member 46 is configured as a result of a lower flange 46A, which corresponds to the upper flange 44, a welding portion 46B, which is positioned on the radial direction inner side of the lower flange 46A and is welded to the lower end of the circular cylinder portion 42A of the reel hub 42, and an annular rib 46C, which projects further downward than the undersurface of the lower flange 46A from the underside of the welding portion 46B, being mutually coaxially formed.

Further, a reel gear 50 that is formed in an annular shape that is coaxial with the reel hub 42 is formed on the undersurface (outer surface) of the bottom plate portion 42B of the reel hub 42. The reel gear 50 is configured to be capable of meshing with a drive gear 102 that is disposed on a rotating shaft 100 of the drive device by relative movement in the axial line direction of the reel 40 (the rotating shaft 100).

Moreover, a reference convex portion 48 whose lower end surface is configured as a reference surface 48A is disposed on, so as to project from, the undersurface of the bottom plate portion 42B on the radial direction inner side of the reel gear 50 and on the radial direction outer side of a later-described reel plate 52. The reference convex portion 48 is formed in an annular shape that is coaxial with the reel 40 and is formed integrally and continuously with the radial direction inner end of the reel gear 50. The reference surface 48A of this reference convex portion 48 contacts a positioning surface 108 of the rotating shaft 100, whereby positioning of the reel 40 in the axial line direction with respect to the drive device is performed.

A ring-shaped member 38 that is coaxial with the reel hub 42 is, as shown in FIG. 2 to FIG. 6, fixedly attached by insert molding or press-fitting adhesion to the inner peripheral surface of the circular cylinder portion 42A of the reel hub 42. This ring-shaped member 38 is molded by a material (a metal, a fiber-reinforced resin, etc.) of a higher strength than the reel hub 42 (the circular cylinder portion 42A) so that the ring-shaped member 38 can reinforce the circular cylinder portion 42A in the radial direction (can control or prevent collapse of the circular cylinder portion 42A toward the center of rotation of the reel 40), and the ring-shaped member 38 is formed in a circular cylinder shape of substantially the same height as the total height of the circular cylinder portion 42A (the upper end surface of the circular cylinder portion 42A and the upper end surface of the ring-shaped member 38 are configured to be substantially even).

Further, the lower end portion (the bottom plate portion 42B side) of this ring-shaped member 38 bends inward in the radial direction so as to become a shape that substantially follows the inner circular cylinder portion 42C, and an engagement gear 54 with which a brake gear 82 of a later-described brake member 80 is capable of meshing is formed on the inner peripheral surface of the lower end portion of the ring-shaped member 38. This engagement gear 54 is formed in an annular shape on the inner peripheral surface of the lower end portion of the ring-shaped member 38 and is formed as inner teeth 54A that are capable of meshing with and releasing meshing from the brake gear 82 by relative movement in the axial line direction. It will be noted that the shape of the inner teeth 54A that configure the engagement gear 54 will be described later together with outer teeth 82A of the brake gear 82.

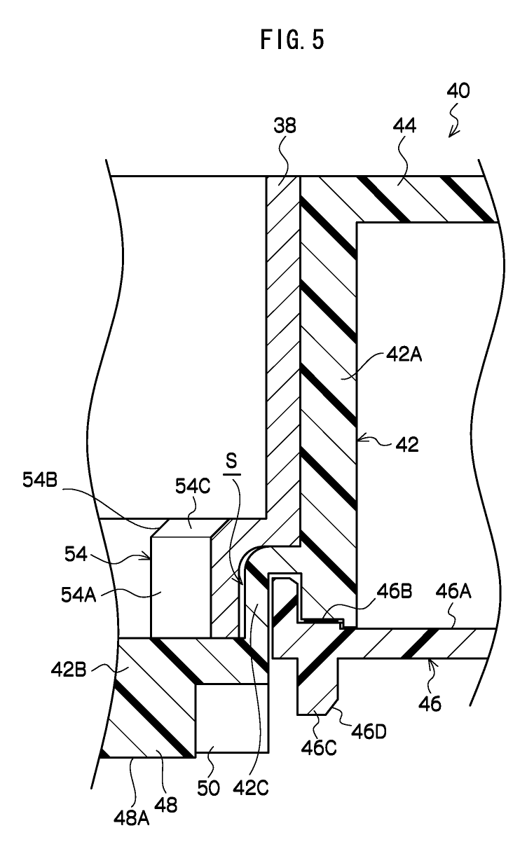

Further, as shown in detail in FIG. 5, the outer peripheral surface of the ring-shaped member 38 on its upper portion side (its upper end portion side from the upper surface of the inner circular cylinder portion 42C) excluding its lower end portion where the engagement gear 54 is formed tightly contacts the inner peripheral surface of the circular cylinder portion 42A of the reel hub 42, but a predetermined space S is formed annularly between the outer peripheral surface of the lower end portion of the ring-shaped member 38 where the engagement gear 54 is formed and the inner peripheral surface of the inner circular cylinder portion 42C of the reel hub 42 (such that the outer peripheral surface of the lower end portion of the ring-shaped member 38 does not contact the inner peripheral surface of the inner circular cylinder portion 42C of the reel hub 42).

Thus, a situation where the rigidity of the circular cylinder portion 42A on its lower end portion side, where the inner circular cylinder portion 42C (the bottom plate portion 42B) is integrally consecutively disposed and whose rigidity is heightened, becomes higher than the rigidity of the circular cylinder portion 42A on its upper portion side (its upper end portion side from the upper surface of the inner circular cylinder portion 42C) excluding its lower end portion is controlled or prevented. In other words, thus, a difference between the upper and lower diameters of the circular cylinder portion 42A of the reel hub 42 resulting from winding constriction of the magnetic tape T can be effectively reduced.

Further, a through hole 55 is disposed in the axial center portion of the bottom plate portion 42B. The through hole 55 is configured to be for operation of the brake member 80 from the outside, and, in the present embodiment, the through hole 55 is also configured to fulfill a centering function during rotational driving of the reel 40 as a result of a release projection 104 of the rotating shaft 100 fitting together with the through hole 55. For that reason, a boss portion 55A is disposed on, so as to project downward from, the edge portion of the through hole 55 in the bottom plate portion 42B so as to ensure a length with which the through hole 55 fits together with the release projection 104. It will be noted that the lower end surface of the boss portion 55A is disposed in substantially the same position as the reference surface 48A.

Further, a disc-shaped reel plate 52, which comprises a magnetic material and in which a hole is formed, is coaxially attached to the undersurface of the bottom plate portion 42B between the reference convex portion 48 and the boss portion 55A. This reel plate 52 is fixedly attached to the bottom plate portion 42B by insert molding or caulking and is attracted to and held by the magnetic force of a magnet 106 of the rotating shaft 100 but does contact the magnet 106. It will be noted that the undersurface of this reel plate 52 is positioned higher than the reference surface 48A.

The reel 40 that has been described above is housed inside the case 12 as shown in FIG. 2, and when the reel 40 is not in use, the reel gear 50, the reference surface 48A and the reel plate 52 are exposed to the outside from the gear opening 18. This will be described specifically below.

The inner diameter of the gear opening 18 in the case 12 is formed so as to substantially coincide with the inner diameter of the annular rib 46C and so as to be larger than the outer diameter of the bottom plate portion 42B of the reel 40. Additionally, when the reel 40 is not in use, the lower end surface of the annular rib 46C is brought into contact with the inner surface (upper surface) of the bottom plate 16A around the gear opening 18, and the bottom plate portion 42B is caused to enter the gear opening 18.

That is, the reel 40 is configured such that, when the reel 40 is not in use, the reel 40 is biased toward the bottom plate 16A of the case 12. It will be noted that the position of the reel 40 at this time is a lowermost position. Additionally, in this recording tape cartridge 10, the dimension of each portion of the reel 40 positioned in the lowermost position is determined such that each portion of the reel 40 positioned in the lowermost position does not project downward from the outer surface (undersurface) of the bottom plate 16A.

Further, in a state where the reel 40 is positioned in the lowermost position, a gap G of a distance W along the axial line direction of the reel 40 is formed between the inner surface of the top plate 14A and the upper end surface of the circular cylinder portion 42A (the upper surface of the upper flange 44) that configures the upper end of the reel 40. This reel 40 is configured such that, when the reel 40 is driven to rotate by the rotating shaft 100, as shown in FIG. 3, the reel 40 floats upward inside the case 12 and rotates without contacting each portion of the case 12. It will be noted that the position of the reel 40 at this time is a floating position.

Further, an annular rib 19 that is coaxial with the gear opening 18 is disposed on, so as to project from, the inner surface of the bottom plate 16A on the radial direction outer side of the gear opening 18. The annular rib 19 is formed such that its inner diameter is slightly larger than the outer diameter of the annular rib 46C and is formed such that the height to which it projects from the bottom plate 16A is slightly smaller than the height to which the annular rib 46C projects from the lower flange 46A.

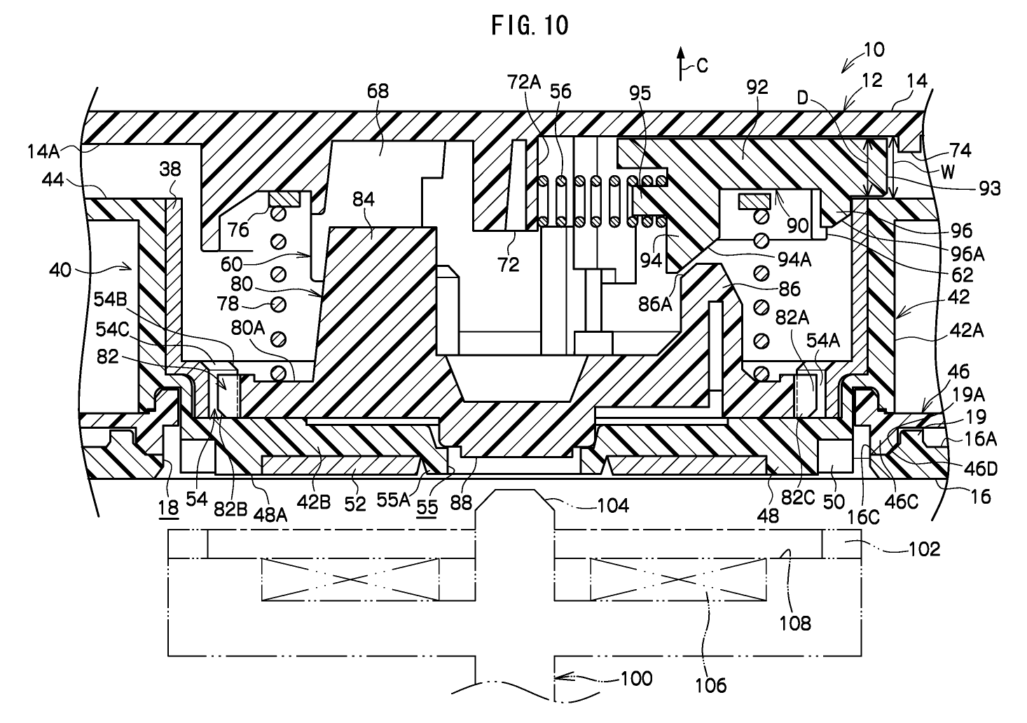

Further, the root portion on the inner surface side of the annular rib 19 is configured as a tapered surface 19A that substantially corresponds to a tapered surface 46D of the annular rib 46C. It will be noted that, below, the portion of the inner surface of the bottom plate 16A on the radial direction inner side of the (tapered surface 19A of the) annular rib 19—that is, the annular site of the bottom plate 16A that the lower end surface of the annular rib 46C contacts when the reel 40 is not in use—will be called a contact surface 16C (see FIG. 10 to FIG. 12).

The annular rib 19 is configured such that, in a state where the reel 40 is positioned in the lowermost position (where the lower end surface of the annular rib 46C contacts the contact surface 16C) and the reel 40 has been centered, neither its inner surface including the tapered surface 19A nor its upper end surface contacts any portion of the reel 40, and the annular rib 19 is configured to prevent the reel 40 from interfering with the annular rib 46C and becoming off-center when the reel 40 tries to become off-center. Further, the tapered surface 46D of the reel 40 is configured to fulfill the function of leading the reel 40 to the inner side of the annular rib 19 when the reel 40 returns to the lowermost position from the floating position.

The reel 40 that has been described above is configured such that, when the reel 40 is not in use, rotation of the reel 40 with respect to the case 12 is deterred as a result of the brake gear 82 of the brake member 80 meshing with the engagement gear 54 that is formed on the inner peripheral surface of the lower end portion of the ring-shaped member 38 that is fixedly attached to the inner peripheral surface of the circular cylinder portion 42A of the reel hub 42. This will be described specifically below.

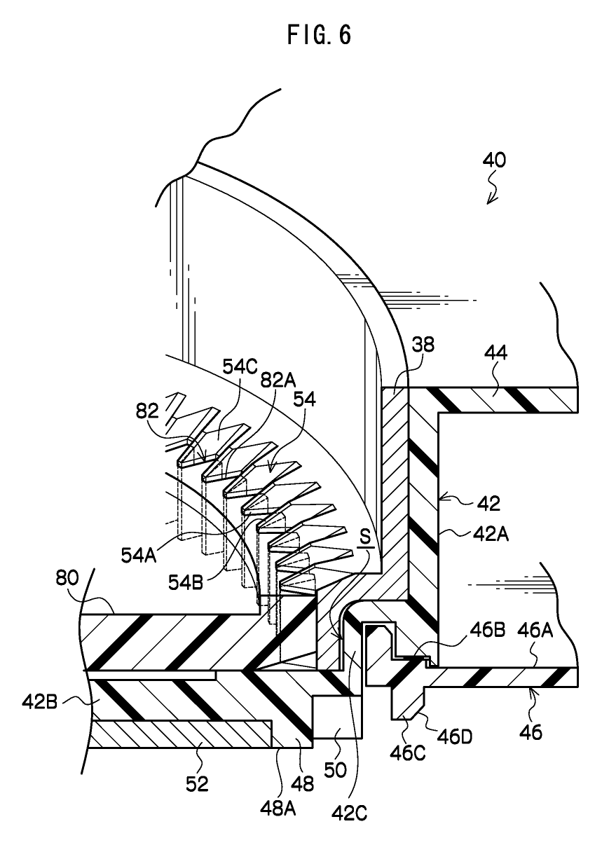

As shown in FIG. 2, FIG. 3, and FIG. 6 to FIG. 8, the recording tape cartridge 10 is equipped with the brake member 80 for deterring rotation of the reel 40 with respect to the case 12. The brake member 80 is formed in a substantial disc shape, and the brake gear 82 that is capable of meshing with the engagement gear 54 of the reel 40 is formed on the outer peripheral portion of the brake member 80. Additionally, the brake member 80 is inserted, substantially coaxially and so as to be movable in the up-and-down (axial line) direction, inside the ring-shaped member 38 that is fixedly attached to the circular cylinder portion 42A of the reel hub 42.

Further, plural (in the present embodiment, three) guide pieces 84 are disposed on, so as to project from, the upper surface of the brake member 80 radially when seen in a planar view. Each of the guide pieces 84 is respectively inserted between later-described guide wall portions 68 of the case 12, whereby the brake member 80 is supported so as to be incapable of rotating with respect to the case 12.

Further, each of the guide pieces 84 is configured to be guided in the up-and-down direction by the guide wall portions 68. That is, the brake member 80 is configured such that relative displacement is allowed only in the up-and-down direction (the axial line direction of the reel 40) with respect to the case 12 by the plural guide pieces 84 and guide wall portions 68. It will be noted that guide means are configured by these plural guide pieces 84 and guide wall portions 68.

Additionally, the brake member 80 is configured such that it can take a rotation lock position (see FIG. 2), where the brake gear 82 is caused to mesh with the engagement gear 54 to deter rotation of the reel 40 with respect to the case 12, and a rotation allowance position (see FIG. 3), where the brake member 80 moves upward from the rotation lock position to release the meshing between the brake gear 82 and the engagement gear 54 and allow rotation of the reel 40 with respect to the case 12.

Specifically, a compression coil spring 78 that serves as a first energizing member is disposed in a compressed state between the top plate 14A of the case 12 (a later-described ring-shaped stopper 76) and a spring receiving surface 80A that is the upper surface of the brake member 80 on the radial direction outer side of the guide pieces 84, and the brake member 80 is configured to be always energized toward the rotation lock position (downward) by the energizing force of the compression coil spring 78.

Further, the reel 40 is configured to be biased in the lowermost position by the energizing force of the compression coil spring 78 that is transmitted to the bottom plate portion 42B via this brake member 80. Consequently, in this embodiment, the rotation lock position of the brake member 80 is configured to be a position in the axial line direction where the brake gear 82 is caused to mesh with the engagement gear 54 of the reel 40 that is biased in the lowermost position.

An operation projection 88 is disposed on, so as to project from, the axial center portion of the undersurface of the brake member 80, and the operation projection 88 enters the inside of the through hole 55 in the reel 40 in a state where the brake member 80 is positioned in the rotation lock position. This operation projection 88 is pressed by the release projection 104 of the rotating shaft 100, whereby the brake member 80 moves from the rotation lock position to the rotation allowance position.

More specifically, in accompaniment with the act of the rotating shaft 100 moving closer to the reel 40 along the axial line direction in order to cause the drive gear 102 to mesh with the reel gear 50, the release projection 104 that projects further upward than the drive gear 102 from the axial center portion of the rotating shaft 100 presses the operation projection 88 to cause the brake member 80 to move to the rotation allowance position counter to the energizing force of the compression coil spring 78.

It will be noted that, at this time, the rotating shaft 100 causes the reel 40 to move to the floating position counter to the energizing force of the compression coil spring 78 in a state where the positioning surface 108 has been brought into contact with the reference surface 48A of the reel 40. Further, engagement projections 86 are disposed on, so as to project from, the upper surface of the brake member 80 in order to allow later-described lock members 90 to be moved from a regulation position to a regulation release position by the movement of the brake member 80 from the rotation lock position to the rotation allowance position. The configuration of these engagement projections 86 will be described later together with the lock members 90.

Here, supplementary description of the engagement gear 54 of the reel 40 and the brake gear 82 of the brake member 80 will be undertaken. As shown in FIG. 4 to FIG. 7, tapered portions 54B and 82B for leading each other toward the axial center are respectively formed on each part of the tooth tip side (radial direction inner end side) and the tooth bottom side of the inner teeth 54A that configure the engagement gear 54 and on each part of the tooth tip side (radial direction outer end side) and the tooth bottom side of the outer teeth 82A that configure the drive gear 82.

That is, the tapered portions 54B are formed on the upper end portion of the tooth tip side of each of the inner teeth 54A as slanted surfaces that face inward in the radial direction and upward. Further, the tapered portions 82B are formed on the lower end portion of the tooth tip side of each of the outer teeth 82A as slanted surfaces that face outward in the radial direction and downward. Further, in this embodiment, as shown in FIG. 6, tapered portions 54C and 82C for leading their partners in the circumferential direction of the reel (mutually between the teeth) are formed on both circumferential direction sides of portions of each of the inner teeth 54A that include the tapered portions 54B and on both circumferential direction sides of portions of each of the outer teeth 82A that include the tapered portions 82B.

Further, the reel 40 is configured such that, when the reel 40 is not in use, displacement of the reel 40 in the axial line direction with respect to the case 12 is regulated (limited) as a result of lock portions 93 of the lock members 90 entering the gap G between the reel 40 and the top plate 14A in a state where the reel 40 is biased in the lowermost position. This will be described specifically below.

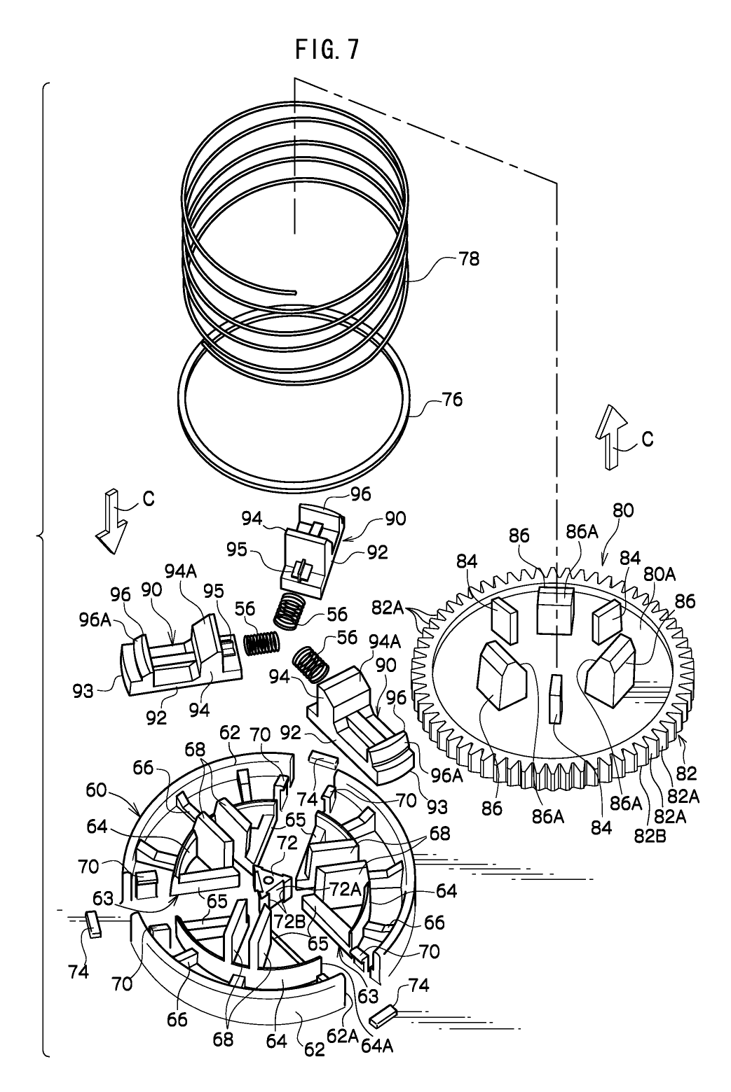

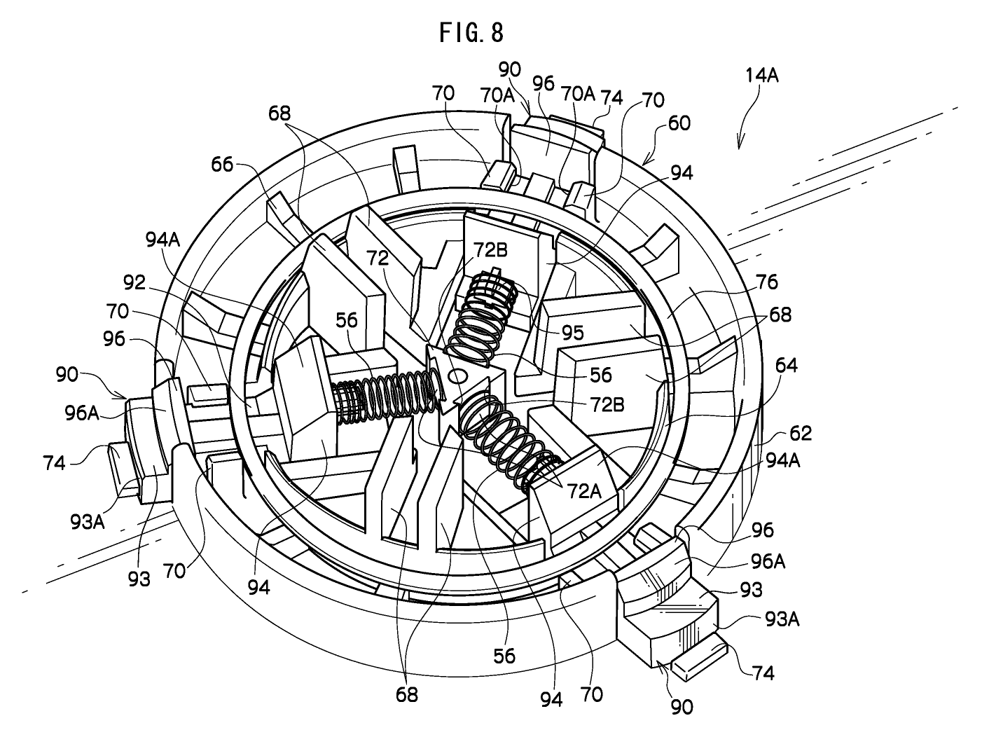

As shown in FIG. 2, FIG. 3, FIG. 7 and FIG. 8, the recording tape cartridge 10 is equipped with a plurality (in the present embodiment, three) of lock members 90 for preventing up-and-down movement of the reel 40 with respect to the case, that is, for preventing the annular rib 46C from moving toward and away from the contact surface 16C. It will be noted that, below, when describing the lock members 90, each direction in an assembled state will be used. Further, in the description below, there are instances where “radial direction” will mean the radial direction of the reel 40 housed in the case 12 or a direction parallel to the radial direction.

As shown in FIG. 7 and FIG. 8, the lock members 90 are formed in a substantially prismatic shape whose longitudinal direction is in the radial direction, and the lock members 90 are equipped with body portions 92 that slidably contact the inner surface of the top plate 14A. The lock portions 93 are disposed on the radial direction outer end sides of the body portions 92. As shown in FIG. 10 to FIG. 12, the upper surfaces of the lock portions 93 are even with the upper surfaces of the body portions 92, and an up-and-down direction thickness D of the lock portions 93 is configured to be slightly smaller than the distance W of the gap G between the upper end surface of the circular cylinder portion 42A of the reel 40 positioned in the lowermost position and the upper end surface of the ring-shaped member 38 and the inner surface of the top plate 14A (D<W).

The lock members 90 are configured such that they can take a regulation position (see FIG. 2), where the lock members 90 move in the radial direction while sliding against the inner surface of the top plate 14A to cause the lock portions 93 to enter the gap G to regulate rising of the reel 40 from the lowermost position, and a regulation release position (see FIG. 3), where the lock members 90 cause the lock portions 93 to retract from the gap G to allow movement of the reel 40 from the lowermost position to the floating position.

It will be noted that, in this recording tape cartridge 10, because the thickness D of the lock portions 93 is set to be slightly smaller than the distance W of the gap G (D<W), a slight clearance is formed between the undersurfaces of the lock portions 93 positioned in the regulation position and the upper surface of the upper flange 44 and between the upper surfaces of the lock portions 93 positioned in the regulation position and the inner surface of the top plate 14A. Thus, the lock portions 93 can smoothly enter and retract from the gap G.

Further, the lock members 90 are equipped with engagement portions 96 that are disposed on the body portions 92 so as to project downward from the radial direction inner end portions of the lock portions 93. The radial direction outer surfaces of the engagement portions 96 are formed in a circular arc shape that corresponds to the inner peripheral surface of the ring-shaped member 38 and are configured to surface-contact the inner peripheral surface of the ring-shaped member 38 when the lock members 90 are positioned in the regulation position.

Consequently, the lock members 90 are prevented from moving outward in the radial direction beyond the regulation position. It will be noted that the draft angles of the engagement portions 96 and (at least the vicinity of the upper end of) the ring-shaped member 38 with respect to the axial line direction of the reel are configured to be substantially 0° such that a clearance does not arise between them. Further, tapered surfaces 96A that have a circular arc shape when seen from the bottom and which face downward and outward in the radial direction are formed on the lower end portions of each of the engagement portions 96 and are configured to be for assembly of the later-described lock members 90.

Moreover, the lock members 90 are equipped with cam portions 94 that serve as pressed portions that are disposed on the body portions 92 so as to project downward from the radial direction inner ends of the body portions 92. The cam portions 94 are configured to cooperate with the engagement projections 86 that serve as pressing portions that are disposed on, so as to project from, the upper surface of the brake member 80 to convert some of the force of movement of the brake member 80 from the rotation lock position to the rotation allowance position into the force of movement of the lock members 90 from the regulation position to the regulation release position, but these configurations will be described later.

Further, the lock members 90 are equipped with fit-in portions 95 that project inward in the radial direction from the respective cam portions 94. The fit-in portions 95 are, as shown in FIG. 7, formed in a substantial cross shape when seen from inward in the radial direction and fit into and hold one end each of later-described compression coil springs 56.

The lock members 90 that have been described above are held, so as to be movable in the radial direction, by a holding portion 60 that is disposed on the inner surface of the top plate 14A of the case 12. Additionally, as shown in FIG. 7 and FIG. 8, the holding portion 60 is disposed upright on the inner surface of the top plate 14A and is equipped with annular walls 62 and 64 that become substantially coaxial with the reel 40 in an assembled state.

It will be noted that the height to which the annular wall 62 positioned on the outer side is disposed upright from the inner surface of the top plate 14A is configured to be larger than the height to which the annular wall 64 on the inner side is disposed upright from the inner surface of the top plate 14A (the lower end of the annular wall 62 is positioned further downward). Further, the outer diameter of the annular wall 62 is configured to be smaller than the inner diameter of the ring-shaped member 38 that is fixedly attached to the inner peripheral surface of the circular cylinder portion 42A of the reel 40, so the holding portion 60 is configured to not interfere with the reel 40 positioned in the floating position.

Notch portions 62A and 64A, which are formed as a result of three places each of the annular walls 62 and 64 that are equidistant in the circumferential direction being cut away across their entire heights, are formed in the annular walls 62 and 64 such that the notch portions 62A and 64A correspond to each other. It will be noted that the opening widths of the notch portions 62A and 64A correspond to the width of the lock members 90. Further, the annular walls 62 and 64 are interconnected by plural support ribs 66 that are disposed on, so as to project from, the inner surface of the top plate 14A. That is, the support ribs 66 in the present embodiment are disposed such that there are three of the support ribs 66 each between each of the notch portions 62A and 64A for a total of nine of the support ribs 66.

Moreover, the holding portion 60 is equipped with three pairs of guide walls 65 that are disposed upright on the inner surface of the top plate 14A and are positioned on the inner side of the annular wall 64. The pairs of guide walls 65 are disposed such that their opposing surfaces coincide with hypothetical lines that interconnect the edge portions of the notch portions 62A and 64A, and the guide walls 65 form, together with the notch portions 62A and 64A, housing portions 63 that house the lock members 90 such that the lock members 90 are movable in the radial direction.

That is, the lock members 90 are disposed at equidistant intervals in the circumferential direction of the reel 40 as a result of being housed in the respectively different housing portions 63 and are configured to be movable (slidable) only in the radial direction on the inner surface of the top plate 14A while being guided by the guide walls 65 and the edge portions of the notch portions 62A and 64A. Further, holding projections 70 are disposed, so as to project from, between the annular walls 62 and 64 and between the edge portions of the notch portions 62A and 64A.

The holding projections 70 are respectively positioned on extension lines of the corresponding guide walls 65, and engagement convex portions 70A that project toward the undersides of the housing portions 63 are disposed on the lower ends of the holding projections 70. The lower ends of the engagement convex portions 70A on the sides where they face their partners are configured as tapered surfaces and engage with the corner portions of the body portions 92 when the lock members 90 are assembled from below.

Thus, when the lock members 90 are to be assembled, the pairs of holding projections 70 deform to allow attachment of the lock members 90 into the housing portions 63, and when the lock members 90 are attached, the engagement convex portions 70A deter the lock members 90 from falling out. That is, the lock members 90 are placed in a provisionally held state where they do not fall out from the holding portion 60 when the inner surface of the top plate 14A is oriented face down (in the vertical direction) and is attached to the lower case 16.

Further, a spring receiving convex portion 72 is disposed in, so as to project from, the axial center portion of the holding portion 60. The spring receiving convex portion 72 is formed in a substantial equilateral triangle prismatic shape that includes three spring receiving surfaces 72A in correspondence to the three lock members 90, and locking claws 72B are formed on both width direction sides of each of the spring receiving surfaces 72A. This spring receiving convex portion 72 is configured to support later-described compression coil springs 56.

Moreover, stopper ribs 74 are disposed on, so as to project from, the inner surface of the top plate 14A on the outer side of the annular wall 62 along a circumference that is coaxial with that annular wall 62. The stopper ribs 74 are disposed on the radial direction outer sides of the housing portions 63 and are configured to stop the lock members 90. It will be noted that the stopper ribs 74 are disposed slightly further outward in the radial direction than radial direction outer ends 93A of the lock portions 93 of the lock members 90 positioned in the regulation position. Further, the height to which the stopper ribs 74 project from the inner surface of the top plate 14A is kept low so that the stopper ribs 74 do not interfere with the reel 40 positioned in the floating position.

Moreover, one set of two guide wall portions 68 is disposed upright between each pair of the guide walls 65 on the inner side of the annular wall 64 of the top plate 14A. That is, there are a total of three sets comprising six of the guide wall portions 68, and the guide wall portions 68 are configured to allow the guide pieces 84 of the brake member 80 to enter between the guide wall portions 68 in each set. Consequently, the distance between the guide wall portions 68 in each set is configured to be equal to, or slightly larger than, the thickness of the guide pieces 84 so that rotation of the brake member 80 can be deterred and rattling is controlled.

Further, the guide wall portions 68 are configured to have a height with which they can maintain a state where the guide pieces 84 of the brake member 80 that moves between the rotation lock position and the rotation allowance position are always inserted between the guide wall portions 68. Additionally, the radial direction inner ends of the guide wall portions 68 are disposed so as to be consecutive with the guide walls 65, and the radial direction outer ends of the guide wall portions 68 are disposed so as to be consecutive with the annular wall 64.

Further, the lock members 90 are held by the ring-shaped stopper 76 that is fixed to the support ribs 66, so that the holding portion 60 is reliably deterred from falling out. That is, the ring-shaped stopper 76 is fixedly attached to the undersides of the support ribs 66 by ultrasonic welding, for example, and is used as a spring receiving member that receives the upper end of the compression coil spring 78. It will be noted that the upper end of the compression coil spring 78 may also be received by the support ribs 66.

Further, compression coil springs 56 that serve as second energizing members that energize the lock members 90 toward the regulation position are disposed in the axial center portion of the holding portion 60. The compression coil springs 56 are disposed for each of the lock members 90, with one end of each of the compression coil springs 56 being fitted over and held on the fit-in portions 95 of the lock members 90 and the other end of each of the compression coil springs 56 being brought into contact with the spring receiving surfaces 72A of the spring receiving convex portion 72. Additionally, positional shifting of the other ends of the compression coil springs 56 with respect to the spring receiving surfaces 72A is prevented by the locking claws 72B of the spring receiving convex portion 72.

Further, the compression coil springs 56 are configured to be in a compressed state in a state where the engagement portions 96 contact the inner peripheral surface of the ring-shaped member 38. That is, the compression coil springs 56 are configured to energize the lock members 90 outward in the radial direction so that the engagement portions 96 are pushed against the inner peripheral surface of the ring-shaped member 38 by the energizing forces of the compression coil springs 56.

Further, in this recording tape cartridge 10, before the upper case 14 and the lower case 16 are joined together, as shown in FIG. 8, the lock portions 93 of the lock members 90 are pushed against the stopper ribs 74 by the energizing forces of the compression coil springs 56. In other words, the compression coil springs 56 are configured to be in a compressed state in a state where the radial direction outer ends 93A of the lock portions 93 of the corresponding lock members 90 contact the stopper ribs 74; thus, the lock members 90 are provisionally held.

Consequently, when the upper case 14 in a state where the lock members 90 are held in this provisional holding position is to be attached to the lower case 16 while the reel 40 is being biased in the lowermost position via the brake member 80 by the compression coil spring 78, the inner edge portion of the upper end of the ring-shaped member 38 engages with the tapered surfaces 96A of the lock members 90, some of the force of assembly in the axial line direction of the reel is converted into the force of movement of the lock members 90 inward in the radial direction, and the lock members 90 move slightly from the provisional holding position to the regulation position counter to the energizing forces of the compression coil springs 56.

It will be noted that, because of this act, the guide pieces 84 of the brake member 80 enter between the corresponding guide wall portions 68 and position the brake member 80 before assembly. Further, because of this act, the door 30 is pivotally supported on the pivot 26. Additionally, by fixedly joining together the upper case 14 and the lower case 16 in this state, the recording tape cartridge 10 is assembled.

Here, in this assembled state, that is, a shipping state that is a state of nonuse, as shown in FIG. 2 and FIG. 10, the reel 40 is positioned in the lowermost position by the energizing force of the compression coil spring 78, the brake member 80 is positioned in the rotation lock position by the energizing force of the compression coil spring 78, and the lock members 90 are positioned in the regulation position by the energizing forces of the compression coil springs 56.

Consequently, rotation of the reel 40 positioned in the lowermost position with respect to the case 12 is deterred by the brake member 80, and movement of the reel 40 in the axial line direction of the reel with respect to the case—that is, movement of the reel 40 to the floating position—is regulated by the lock members 90. The recording tape cartridge 10 in this state is referred to as being in a state of nonuse (time of nonuse). Additionally, in this recording tape cartridge 10, as described above, the lock members 90 move from the regulation position to the regulation release position because of the movement of the brake member 80 from the rotation lock position to the rotation allowance position by the rotating shaft 100.

To describe this specifically, as shown in FIG. 7 and FIG. 8, tapered surfaces 86A that face inward in the radial direction and upward are formed on the upper ends of the engagement projections 86 that are disposed on, so as to project from, the upper surface of the brake member 80, tapered surfaces 94A that face outward in the radial direction and downward are formed on the lower ends of the cam portions 94 that are disposed on, so as to project downward from, the radial direction inner ends of the lock members 90, and the tapered surfaces 86A and the tapered surfaces 94A are configured as slanted surfaces that correspond to each other such that they are capable of surface-contacting each other. It will be noted that this angle of inclination is set within the range of 30° to 60° and is configured to be 45° in the present embodiment.

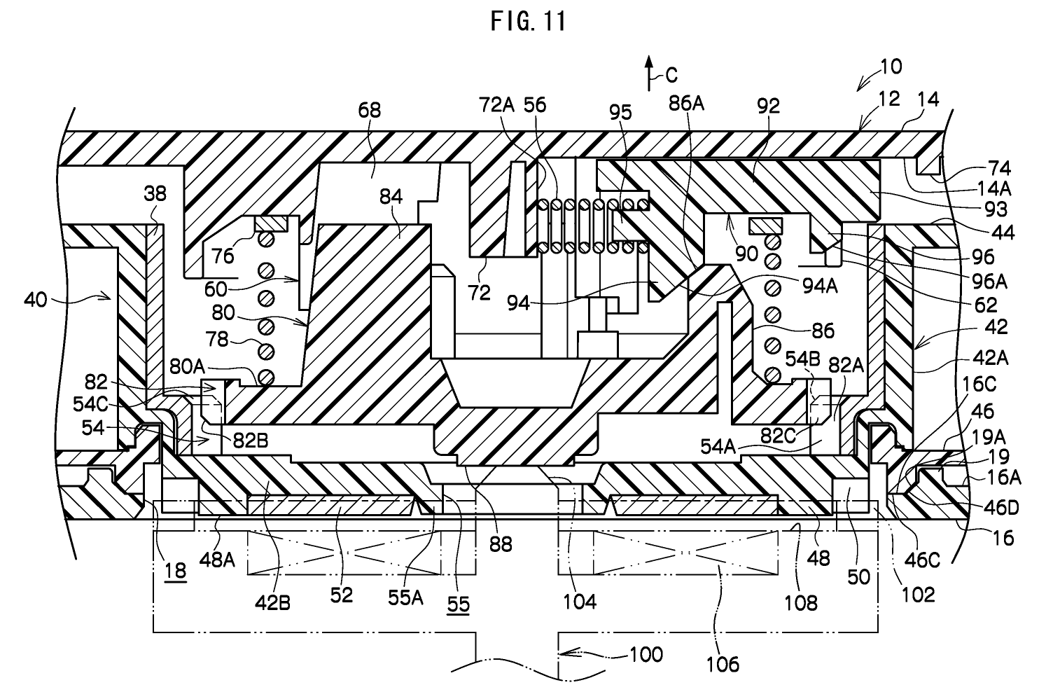

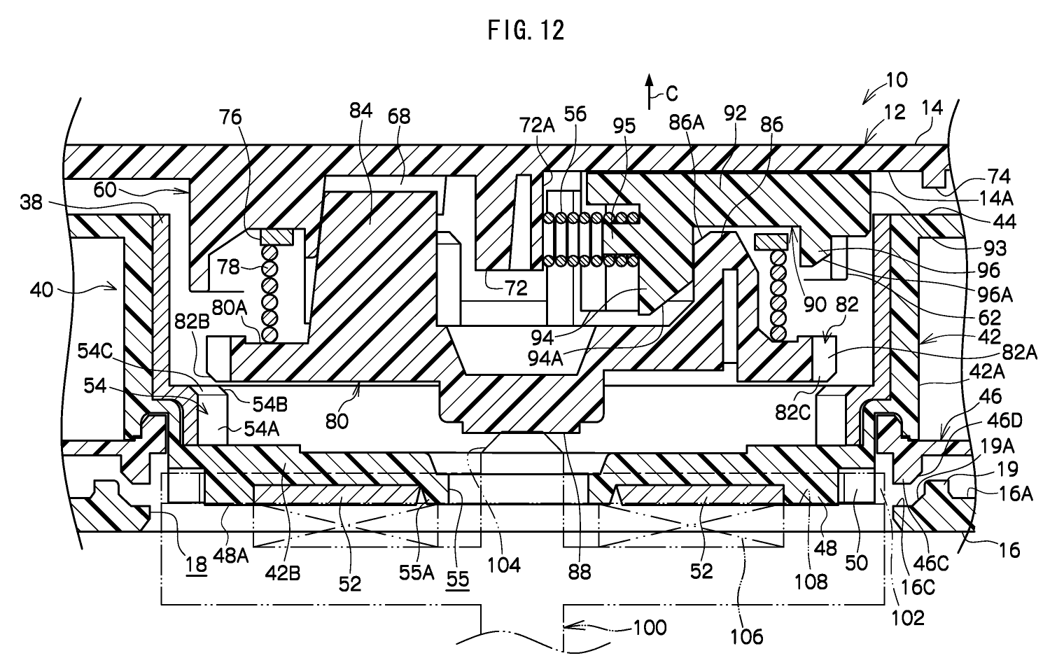

When the brake member 80 is moved upward with respect to the case 12 by the rotating shaft 100, the tapered surfaces 86A and the tapered surfaces 94A contact each other and convert the force of movement of the brake member 80 upward (upward in the axial line direction in the reel) into a force of movement that causes the lock members 90 to move inward in the radial direction. Thus, the recording tape cartridge 10 passes through the state shown in FIG. 11 to a state where, as shown in FIG. 3 and FIG. 12, the lock members 90 move to the regulation release position, the brake member 80 moves to the rotation allowance position and the reel 40 moves to the floating position.

Additionally, the recording tape cartridge 10 in this state is referred to as being in a state of use (time of use). In this state of use, the cam portions 94 of the lock members 90 are caused to enter the inner sides of the corresponding engagement projections 86 of the brake member 80, and the radial direction outward-facing surfaces of the cam portions 94 are brought into contact with the radial direction inward-facing surfaces of the corresponding engagement projections 86.

It will be noted that, at this time, the draft angles of the radial direction outward-facing surfaces of the cam portions 94 of the lock members 90 and the radial direction inward-facing surfaces of the engagement projections 86 of the brake member 80 are set to be substantially 0° to ensure that, in the state of use, component forces resulting from the energizing forces of the compression coil spring 78 and the compression coil springs 56 do not act in the axial line direction of the reel 40 on these surfaces.

Further, as shown in FIG. 10, in the state of nonuse, a predetermined clearance is set between the tapered surfaces 86A of the engagement projections 86 and the tapered surfaces 94A of the cam portions 94. Thus, it is ensured that, in the state of nonuse, component forces resulting from the energizing forces of the compression coil springs 56 do not act on the brake member 80.

Further, this clearance (separation distance along the axial line direction of the reel) is set to be smaller than the meshing amount along the axial line direction of the reel between the brake gear 82 and the engagement gear 54. That is, the tapered surfaces 86A and 94A do not interfere with (contact) each other before the meshing between the brake gear 82 and the engagement gear 54 is released.

Here, there are instances where, in a state where the lock members 90 are positioned in the regulation position, the reel 40 slants with respect to the case 12 due to the slight clearance (W−D) in which the reel 40 is capable of being displaced in the axial line direction thereof. That is, there are instances where the reel 40 slants with respect to the case 12 such that the lock members 90 and the top plate 14A are brought into contact with each other centering on the site of the reel 40 that contacts the portion of the case 12 on the bottom plate 16A side.

In this instance, when the reel 40 slants such that two of the lock members 90 of the plural lock members 90 contact the top plate 14A, the amount of displacement of the reel 40 in the reel axial line direction with respect to the case 12 becomes a maximum between those two lock members 90 and the amount of displacement of the engagement gear 54 in the reel axial line direction with respect to the case 12 becomes a maximum.

However, the stroke for releasing the meshing amount between the engagement gear 54 and the brake gear 82 (the distance along the reel axial line direction until the outer teeth 82A of the brake gear 82 escape from between the inner teeth 54A of the engagement gear 54) is larger than the maximum displacement amount of the engagement gear 54 with respect to the case 12, so when, for example, the recording tape cartridge 10 is dropped or the like, the meshing between the brake gear 82 and the engagement gear 54 is maintained in all of the teeth that are formed in the circumferential direction.

That is, when the reel 40 slants with respect to the case 12 as a result of the recording tape cartridge 10 being dropped or the like, for example, there is concern that, in accompaniment with this, the brake member 80 will cause a tracking delay with respect to the reel 40 returning to its initial position and for the rotation lock to be released because the brake member 80 causes relative displacement with respect to the case 12 while it is guided by the guide means (the guide pieces 84 and the guide wall portions 68).

However, in this recording tape cartridge 10, the meshing between the engagement gear 54 and the brake gear 82 is maintained at each portion in the circumferential direction with respect to maximum slanting of the reel 40 with respect to the case 12 (the meshing amount between the engagement gear 54 and the brake gear 82 is greater than the maximum displacement amount of the reel 40 (the engagement gear 54) with respect to the case 12 resulting from the above-described clearance (W−D)). Consequently, in this recording tape cartridge 10, a situation where the rotation lock of the reel 40 with respect to the case 12 is released as a result of the recording tape cartridge 10 being dropped or the like is more effectively prevented.

Next, the action of the recording tape cartridge 10 of the above-described configuration will be described. In the recording tape cartridge 10 of the above-described configuration, when the recording tape cartridge 10 is not in use (when the recording tape cartridge 10 is not loaded into the drive device) such as during storage or during transport, the door 30 blocks off the opening 20 because of the energizing force of the torsion spring 28. Further, the leader tape 22 is disposed along the left side wall 12B as a result of the projecting portions 22B of the leader tape 22 being housed (inserted) and held inside the slot portions 24.

Further, because of the energizing force of the compression coil spring 78, the reel 40 is positioned in the lowermost position, where the lower end surface of the annular rib 46C is brought into contact with the contact surface 16C of the case 12, and the brake member 80 is positioned in the rotation lock position, where the brake gear 82 is caused to mesh with the engagement gear 54 of the reel 40.

Moreover, because of the energizing forces of the compression coil springs 56, the lock members 90 are positioned in the regulation position where the lock portions 93 of the lock members 90 are caused to enter the gap G between the inner surface of the top plate 14A and the upper end surfaces of the ring-shaped member 38 and the circular cylinder portion 42A. That is, as shown in FIG. 2 and FIG. 10, the recording tape cartridge 10 is in the state of nonuse.

Thus, rotation of the reel 40 with respect to the case 12 is deterred, and up-and-down movement of the reel 40 with respect to the case 12 is regulated to be equal to or less than an allowable amount (an amount obtained by subtracting the thickness D of the lock portions 93 from the up-and-down direction distance W of the gap G). Consequently, even when a user inadvertently presses the bottom portion of the reel 40 (the reel plate 52, etc.) or drops the recording tape cartridge 10, a situation where the reel 40 rattles or slants inside the case 12 (shifts in orientation) is controlled.

When the magnetic tape T is to be used, the recording tape cartridge 10 is loaded from the front wall 12A side into a bucket (not shown) of the drive device. In accompaniment with this loading operation, the opening/closing member (not shown) of the drive device presses the portion of the door 30 on the right side of the pivot 26. Then, the door 30 pivots about the pivot 26 counter to the energizing force of the torsion spring 28 such that the opening 20 is opened.

Next, while the opened state of the opening 20 is maintained, the bucket descends and the rotating shaft 100 of the drive device relatively moves closer to the case 12 from below (the rotating shaft 100 moves upward with respect to the case 12). Then, as shown in FIG. 11, the release projection 104 of the rotating shaft 100 pushes the operation projection 88 of the brake member 80, enters the through hole 55 in the reel 40, and fits together with the through hole 55. Thus, the brake member 80 is pushed upward counter to the energizing force of the compression coil spring 78 (the brake member 80 moves to a relative rotation allowance position with respect to the reel 40) and the rotation lock state of the reel 40 resulting from the brake member 80 is released.

Further, in accompaniment with this movement of the brake member 80 upward, the tapered surfaces 86A of the engagement projections 86 and the tapered surfaces 94A of the cam portions 94 of the lock members 90 slide against each other and convert the force of movement of the brake member 80 upward into the force of movement of the lock members 90 inward in the radial direction. Thus, the lock members 90 move from the regulation position to the regulation release position.

Then, when the rotating shaft 100 moves further upward, this rotating shaft 100 further pushes the brake member 80 upward to cause the drive gear 102 to mesh with the reel gear 50. Thus, the lock portions 93 of the lock members 90 completely exit from the gap G before the reference surface 48A of the reel 40 contacts the positioning surface 108 of the rotating shaft 100.

When the positioning surface 108 of the rotating shaft 100 contacts the reference surface 48A of the reel 40, the rotating shaft 100 moves further upward together with the reel 40 and the brake member 80. Then, when the bucket descends by a set stroke and stops, movement of the rotating shaft 100 with respect to the case 12 stops, and, as shown in FIG. 3 and FIG. 12, the reference surface 48A of the reel 40 contacts the positioning surface 108 in the axial line direction of the reel 40, and the reel 40 is positioned in a floating rotatable position inside the case 12.

In this state, the reel 40 is held on the rotating shaft 100 by the force of attraction with which the magnet 106 attracts the reel plate 52. Further, in this state, the brake member 80, whose operation projection 88 is contacting the release protection 104, is held in the rotation allowance position (an absolute rotation allowance position with respect to the case 12).

Further, when the release projection 104 fits together with the through hole 55 as described above, the reel 40 is centered with respect to the rotating shaft 100. Moreover, the cam portions 94 of the lock members 90 are positioned on the inner sides of the corresponding engagement projections 86 of the brake member 80 that is being held in the rotation allowance position (positioned in an absolute regulation release position with respect to the case 12), and movement of the lock members 90 outward in the radial direction—that is, toward the regulation position—is reliably deterred.

Meanwhile, the unillustrated pullout member of the drive device moves closer to the opening 20 from the left side wall 12B side and engages with the hole portion 22A in the leader tape 22. At this time, the leader tape 22 is standing by in a state where it is close to the left side wall 12B, so the pullout member can reliably engage with the hole portion 22A. The pullout member that has engaged with the hole portion 22A separates from the opening 20, pulls out the leader tape 22 from the case 12, and causes this leader tape 22 to engage with an unillustrated take-up reel of the drive device such that the leader tape 22 is capable of being taken up on the take-up reel.

From this state, the drive device drives the take-up reel and the rotating shaft 100—that is, the reel 40—to rotate synchronously. Thus, the magnetic tape T is sequentially fed out to the drive device. Then, recording of data to the magnetic tape T or reproduction of data recorded on the magnetic tape T is performed by a recording and reproducing head (not shown) that is disposed along a predetermined tape path of the drive device.

When the recording tape cartridge 10 is to be removed from the drive device, first, the drive gear 102 and the rotating shaft 100—that is, the reel 40—are reversely rotated to rewind the magnetic tape T onto the reel 40. Then, the leader tape 22 is removed from the take-up reel and returned through the opening 20 to the inside of the case 12. In other words, the projecting portions 22B of the leader tape 22 are stored (inserted) inside the slot portions 24 and held in predetermined positions inside the case 12.

Next, the drive device raises the bucket, that is, the recording tape cartridge 10. Then, the meshed state between the reel gear 50 and the drive gear 102 is released, the release projection 104 withdraws from the through hole 55, the contact between the operation projection 88 and the release projection 104 is released, and the brake member 80 returns to the rotation lock position where the brake gear 82 is caused to mesh with the engagement gear 54 by the energizing force of the compression coil spring 78.

It will be noted that, at this time, the brake gear 82 of the brake member 80 can smoothly mesh with the engagement gear 54 because the tapered surfaces 82B and 82C are formed on the brake gear 82 of the brake member 80 and the tapered surfaces 54B and 54C are formed on the engagement gear 54. Further, at this time, the reel 40 also moves downward and returns to the lowermost position because of the energizing force of the compression coil spring 78. Then, the brake member 80 returns to the rotation lock position, whereby it becomes possible for the lock members 90 to move outward in the radial direction and return to the regulation position where the lock portions 93 are caused to enter the gap G by the energizing force of the compression coil springs 56.

In this state, the recording tape cartridge 10 is ejected from the bucket. The engaged state between the opening/closing member of the drive device and the door 30 is released by this ejection operation, and the door 30 returns to the position where the door 30 blocks off the opening 20 because of the energizing force of the torsion spring 28. Thus, the recording tape cartridge 10 that has been ejected from the bucket of the drive device returns to its initial state where the opening 20 is blocked off and where rotation and up-and-down movement of the reel 40 are deterred.

In this connection, there are instances where, when a user drops the recording tape cartridge 10 onto the floor or the like, the reel 40 slants with respect to the case 12 inside the case 12 counter to the energizing force of the compression coil spring 78 because of that drop impact or the like. In this instance, the brake member 80 is pushed up toward the top plate 14A counter to the energizing force of the compression coil spring 78 by the reel 40 slanting with respect to the reel 12 while the orientation of the brake member 80 with respect to the case 12 is substantially maintained by the engagement between the guide wall portions 68 and the guide pieces 84.

Here, when this recording tape cartridge 10 is not in use, relative displacement in the axial line direction between the reel 40 and the case 12 is limited because the lock portions 93 of the lock members 90 enter between the reel 40 that is biased toward the bottom plate 16A inside the case 12 and the top plate 14A. Consequently, even if the recording tape cartridge 10 were to be dropped (even if a drop impact is applied to the case 12), slanting of the reel 40 with respect to the case 12 would be controlled. Thus, the relative slanting amount between the reel 40 and the brake member 80 where a change in orientation (slanting) with respect to the case 12 is limited by the engagement between the guide wall portions 68 and the guide pieces 84 is also limited.

Additionally, in this recording tape cartridge 10, rotation of the reel 40 with respect to the case 12 is locked as a result of the engagement gear 54 that is configured by the inner teeth 54A of the reel hub 42 (the ring-shaped member 38) and the brake gear 82 that is configured by the outer teeth 82A of the brake member 80 being caused to mesh with each other, so a large meshing amount (overlap in the axial line direction) between the inner teeth 54A and the outer teeth 82A can be set (ensured) in comparison to a configuration where, for example, gears are formed on the undersurface of the brake member and the upper surface of the bottom portion of the reel hub that face each other.

Consequently, in this recording tape cartridge 10, it is easy for the meshing between the engagement gear 54 and the brake gear 82 to be maintained within the range of the relative slanting amount between the reel 40 and the brake member 80 that is limited by the lock members 90. In other words, the engagement gear 82 and the engagement gear 54 are configured by the outer teeth 82A and the inner teeth 54A, which coincide with the radial direction, and configure a meshing surface along the reel axial line direction, so the meshing between the brake gear 82 and the engagement gear 54 can be maintained without the meshing of the brake gear 82 with respect to the engagement gear 54 being released by rotational force of the reel 40 resulting from a drop impact.

Moreover, because the main meshing surface of the engagement gear 54 and the brake gear 82 is substantially parallel to the reel axial line direction as described above, there is no situation where a force that tries to cause the reel 40 to rotate causes a thrust force to arise between the engagement gear 54 and the brake gear 82 (the thrust force is remarkably small), and the rotation lock state of the reel 40 with respect to the case 12 is excellently maintained as long as the meshing is maintained even slightly. In this manner, in this recording tape cartridge 10, a situation where the rotation lock of the reel 40 with respect to the case 12 is released in accompaniment with the recording tape cartridge 10 being dropped can be prevented.

Further, there are instances where, when the leader tape 22, whose projecting portions 22B are inserted into the slot portions 24 and which is held with respect to the case 12, is pulled inward of the case from this held state, the projecting portions 22B are deformed while interfering with the stopper wall portions 24B of the slot portions 24 and end up crossing over the stopper wall portions 24B. In this instance, appropriate holding of the leader tape 22 with respect to the case 12 is dissolved, so it becomes difficult for the drive device to thereafter pull out the magnetic tape T.

However, in this recording tape cartridge 10, rotation of the reel 40 with respect to the case 12 that accompanies a drop is prevented as described above, so dissolution of the held state of the leader tape 22 with respect to the case 12 resulting from the leader tape 22 being pulled inward of the case is prevented or effectively controlled.

Further, in this recording tape cartridge 10, the engagement gear 54 is formed on the ring-shaped member 38 that is a separate member from the reel hub 42, and this ring-shaped member 38 is attached to the inner peripheral surface of the circular cylinder portion 42A of the reel hub 42, so the plate thickness of the reel hub 42 can be made substantially more even in the up-and-down direction than a conventional reel hub (circular cylinder portion) where the engagement gear 54 is formed integrally. Consequently, a difference between the upper and lower diameters of the reel hub 42 (the circular cylinder portion 42A) resulting from winding constriction of the magnetic tape T can be reduced.

Further still, in this recording tape cartridge 10, the upper end side of the ring-shaped member 38 (its upper end portion side from the upper surface of the inner circular cylinder portion 42C) excluding its lower end portion where the engagement gear 54 is formed tightly contacts the inner peripheral surface of the circular cylinder portion 42A, and the predetermined space S is formed between the outer peripheral surface of the lower end portion side of the ring-shaped member 38 and the inner circular cylinder portion 42C of the circular cylinder portion 42A (such that the outer peripheral surface of the lower end portion of the ring-shaped member 38 does not contact the inner peripheral surface of the inner circular cylinder portion 42C), so the strength of the upper portion side of the circular cylinder portion 42A (its upper end portion side from the upper surface of the inner circular cylinder portion 42C) excluding its lower end portion side can be raised, and a situation where the strength of the circular cylinder portion 42A on its lower end portion side becomes higher than the strength of the circular cylinder portion 42A on its upper portion side can be controlled or prevented (see FIG. 5).

In other words, by the ring shaped member 38, a situation where the rigidity of the circular cylinder portion 42A on its lower end portion side, where the inner circular cylinder portion 42C (the bottom plate portion 42B) is integrally consecutively disposed and whose rigidity is heightened, becomes higher than the rigidity of the circular cylinder portion 42A on its upper portion side (its upper end portion side from the upper surface of the inner circular cylinder portion 42C) excluding its lower end portion is controlled or prevented. Consequently, a difference between the upper and lower diameters of the outer peripheral surface of the circular cylinder portion 42A resulting from winding constriction of the magnetic tape T can be effectively reduced. Thus, it can be ensured that the magnetic tape T that is wound around this reel hub 42 (the outer peripheral surface of the circular cylinder portion 42A) is not adversely affected.

Further, there is also the advantage that design of the engagement gear 54 becomes easy because contraction of the engagement gear 54 resulting from winding constriction of the magnetic tape T can be prevented. Further, the ring-shaped member 38 is formed separately from the reel 40 and raises the rigidity (strength) of the reel hub 42 (the circular cylinder portion 42A), so even when an expensive material is used in order to raise the rigidity of the circular cylinder portion 42A (for the ring-shaped member 38), it becomes possible to accommodate this with a small quantity, and it also becomes unnecessary to make the plate thickness of the circular cylinder portion 42A thicker, so a situation where molding defects such as sinking occur during molding of the reel hub 42 (the circular cylinder portion 42A) can be controlled.

The recording tape cartridge 10 pertaining to the present invention has been described above on the basis of the embodiment shown in the drawings, but the recording tape cartridge 10 pertaining to the present invention is not limited to the embodiment shown in the drawings and is capable of having its design appropriately altered within a range that does not depart from the gist of the present invention. For example, in the preceding embodiment, the engagement gear 54 configured by the inner teeth 54A was disposed across the entire circumference of the ring-shaped member 38 and the brake gear 82 configured by the outer teeth 82A was disposed across the entire circumference of the brake member 80, but either one of the engagement gear 54 and the brake gear 82 may also be configured such that the inner teeth 54A or the outer teeth 82A are disposed partially in the circumferential direction.

Further, as long as the tooth surface (meshing surface) is formed substantially parallel to the axial line of the reel 40, the engagement gear 54 that is formed on the ring-shaped member 38 may also be configured such that, for example, a bottom wall portion (not shown) is disposed integrally so as to extend from the lower end surface of the ring-shaped member 38 toward the upper surface of the bottom plate portion 42B and such that the engagement gear 54 is disposed upright from this bottom wall portion. In this instance, the brake gear 82 of the brake member 80 may also be disposed upright, from the underside of the brake member 80 that faces the bottom wall portion of the ring-shaped member 36 in the up-and-down direction, such that the tooth surface (meshing surface) becomes substantially parallel to the axial line of the reel 40, whereby the brake gear 82 meshes with the engagement gear 54.

Further, in the preceding embodiment, the upper flange 44 was disposed integrally with the reel hub 42, but the lower flange 46A may be formed integrally with the reel hub 42 and the upper flange 44 may be fixedly attached to the upper end surface of the circular cylinder portion 42A by ultrasonic welding or the like. In this instance, a cylindrical portion that fits inside the ring-shaped member 38 may be disposed on the inner edge of the upper flange 44, and the engagement portions 96 of the lock members 90 positioned in the regulation position may be brought into contact with the inner peripheral surface of this cylindrical portion.

Further, in the preceding embodiment, the lock members 90 were configured such that they can take the regulation position and the regulation release position by moving in the radial direction of the reel 40, but the lock members 90 may also, for example, be configured such that they can take the regulation position and the regulation release position by moving in a direction intersecting the radial direction of the reel 40 or may be configured such that they can take the regulation position and the regulation release position by pivoting about predetermined support points.

Further, in the preceding embodiment, an example has been described where the opening 20 disposed in the corner portion 12C of the case 12 is opened and closed by the hinged door 30 and where the leader tape 22 that serves as a leader member is connected to the leading end of the magnetic tape T, but it goes without saying that the present invention is not limited by the configurations of the opening 20 for pulling out the magnetic tape T in the case 12, the shielding member (the door 30) that opens and closes the opening 20, and the leader member (the leader tape 22).

Further still, in the preceding embodiment, the magnetic tape T was used as the recording tape, but the present invention is not limited to this. It suffices as long as the recording tape is understood to be an elongate tape-like information recording and reproducing medium that is capable of recording information and reproducing recorded information, and it goes without saying that the recording tape cartridge 10 pertaining to the present invention is applicable to recording tape of any recording and reproducing format.

What is claimed is:

1. A recording tape cartridge comprising:
a reel that includes a bottomed circular cylinder-shaped hub onto whose outer peripheral surface is wound recording tape;
a case that includes a top plate and a bottom plate that face each other, with the reel being singly housed in the case such that the reel is movable along an axial line direction between the top plate and the bottom plate;
a ring-shaped member that is fixedly attached to the inner peripheral surface of the hub;
an engagement gear that is formed on the ring-shaped member such that its tooth surface is substantially parallel to the axial line of the reel; and
a brake member that is supported so as to be incapable of rotating with respect to the case, includes a brake gear that is capable of meshing with the engagement gear, and, by being displaced in the axial line direction of the reel with respect to the hub, can take a rotation lock position where the brake gear meshes with the engagement gear and a rotation allowance position where the meshing is released.

2. The recording tape cartridge according to claim 1, wherein the engagement gear is formed on the hub bottom wall side of the ring-shaped member, and a space is formed between the outer peripheral surface of the ring-shaped member on the bottom wall side where the engagement gear is formed and the inner peripheral surface of the hub.

3. The recording tape cartridge according to claim 1, wherein the ring-shaped member is formed by a material of higher strength than the hub.

4. The recording tape cartridge according to claim 1, further comprising
a first energizing member that applies an energizing force that biases the reel toward the bottom plate and biases the brake member toward the rotation lock position,
lock members that are plurally disposed along a circumferential direction of the hub and can take a regulation position where the lock members enter between an end portion of the reel on the top plate side and the top plate in a state where the reel is biased toward the bottom plate, and regulate movement of the reel in the axial direction with respect to the case, and a regulation release position where the lock members retract from the regulation position and allow movement of the reel in the axial line direction with respect to the case,
second energizing members that apply energizing forces that bias the lock members toward the regulation position, and
a lock release mechanism that includes pressed portions that are disposed on the plural lock members and pressing portions that are disposed on the brake member, with the lock release mechanism causing the plural lock members to move from the regulation position to the regulation release position as a result of the pressing portions pressing the pressed portions in accompaniment with the brake member moving from the rotation lock position to the rotation release position.

5. The recording tape cartridge according to claim 1, further comprising lock members which, when the brake member is in the rotation lock position, regulate movement of the reel in the axial line direction by entering between an end portion of the reel on the top plate side and the top plate and, when the brake member is in the rotation allowance position, retract from between the end portion of the reel on the top plate side and the top plate to allow movement of the reel in the axial line direction with respect to the case.

6. A recording tape cartridge comprising:
a reel that includes a bottomed circular cylinder-shaped hub onto whose outer peripheral surface is wound recording tape;
a case that includes a top plate and a bottom plate that face each other, with the reel being singly housed in the case such that the reel is movable along an axial line direction between the top plate and the bottom plate;
a ring-shaped member that is fixedly attached to the inner peripheral surface of the hub;
an engagement gear that is formed on the ring-shaped member such that its tooth surface is substantially parallel to the axial line of the reel;
a brake member that is supported so as to be incapable of rotating with respect to the case, includes a brake gear that is capable of meshing with the engagement gear, and, by being displaced in the axial line direction of the reel with respect to the hub, can take a rotation lock position where the brake gear meshes with the engagement gear and a rotation allowance position where the meshing is released; and
lock members which, when the brake member is in the rotation lock position, regulate movement of the reel in the axial line direction and, when the brake member is in the rotation allowance position, allow movement of the reel in the axial line direction with respect to the case.

7. The recording tape cartridge according to claim 6, wherein the engagement gear is formed on the hub bottom wall side of the ring-shaped member, and a space is formed between the outer peripheral surface of the ring-shaped member on the bottom wall side where the engagement gear is formed and the inner peripheral surface of the hub.

8. The recording tape cartridge according to claim 6, wherein the ring-shaped member is formed by a material of higher rigidity than the hub.

9. The recording tape cartridge according to claim 6, further comprising an energizing member that applies an energizing force that biases the reel toward the bottom plate and biases the brake member toward the rotation lock position, and in a state where the reel is biased toward the bottom plate, the lock members are positioned in a regulation position where the lock members regulate movement of the reel in the axial line direction by entering between an end portion of the reel on the top plate side and the top plate.

10. The recording tape cartridge according to claim 6, further comprising a lock release mechanism that allows movement of the reel in the axial line direction with respect to the case by causing the lock members to retract from the regulation position in accompaniment with the brake member moving from the rotation lock position to the rotation release position.
